(19) United States
(12) Patent Application Publication
(10) Pub. No.: US 2005/0180778 A1
(43) Pub. Date: Aug. 18, 2005

(54) Enlarging and reducing templates

(76) Inventor: Ian Woodburn Hooley, Gordon Australian Capital Territory (AU)

Correspondence Address: WELSH & KATZ, LTD, 120 S RIVERSIDE PLAZA, 22ND FLOOR, CHICAGO, IL, 60606, US

(21) Appl. No.: 10/523,495

(22) PCT Filed: Aug. 13, 2003
(86) PCT No.: PCT/AU03/01022

(30) Foreign Application Priority Data
Aug. 13, 2002 (AU) 2002950881

(51) Int. Cl. G03G 15/041

(52) U.S. Cl. 399/197

(57) ABSTRACT

An enlarging or reducing template (1) for use in copying an image (10). The template (1) is formed from a sheet of material on which a series of individually identifiable regions (3) is marked. Each region (3) has a shape and area related by a scaling factor (8) to an output sheet size or imaging region (25) of a copying machine (20). The scaling factor (8) respectively corresponding to each region (3) is indicated on the sheet (1). The scaling factor (8) required to perform a copying operation on the copying machine (20) in respect of an original image (10) can be determined by reference to the regions (3) on the template (1).

### FIELD OF THE INVENTION

This invention relates to a scaling template for use in copying an image. The term scaling as used in the specification is intended to refer to the amount of enlargement or reduction of the size of an original image during a copying process. This is frequently referred to as a “zoom” factor and usually expressed as a percentage of the original size of the image. The present invention is intended for use with photocopiers and scanners of generally conventional type.

Throughout the specification the term “copying machine” is intended to refer to either a photocopier or a scanner whether stand alone devices or incorporated in multi-function devices including combined scanners, copiers and printers.

### BACKGROUND ART

The need to copy an original image in enlarged or reduced format arises frequently. This can be for reasons of convenience or aesthetics. In some cases it is desirable to size the image appropriately in relation to standard paper sizes used by copying machines. Irrespective of the reason for enlargement or reduction it is necessary for each image to establish the desired enlargement or reduction referred to in this specification as a scaling factor. Most copying machines have a scaling ability or “zoom” function that enables the image to be copied in an enlarged or reduced form. The amount of enlargement and reduction available varies from one machine to another. All machines however have an imaging area used for the copying process. Often it is possible to use select imaging areas corresponding to different paper sizes on the one machine. If a scaling factor of 100% is used then the whole of the imaging area on the machine is copied during the copying process and reproduced at the same size (within machine accuracy and margin characteristic limitations) on paper of selected size. If a scaling factor more than 100% is used then only a portion of the imaging area of the copying machine is printed to the paper of selected size in accordance with the enlarging or scaling factor. Similarly when a reduction is performed the imaging area of the copying machine is copied to a smaller area on the output medium paper at a correspondingly reduced size.

Determining the desired scaling factor for a particular copying operation is frequently a tedious task. Whilst it is possible to determine this by measurement and calculation this is often inconvenient, excessively time consuming and frustrating. Typically a person wishing to make an enlarged or reduced size copy makes a rough estimate or simply guesses the required scaling factor to make a copy. Unless this happens to immediately produce the required result, repeated revisions and trial copies are usually made to obtain the required position and size of image.

U.S. Pat. No. 5,678,146 describes an attempt to address these problems. In that patent a measuring apparatus for determining the appropriate level of magnification to reproduce a document onto an output sheet with pre-determined dimensions is disclosed. The L-shaped device may be mounted to the surface of a copy machine or can be attached to the platen glass of a copying machine. The original document is properly lined up with a measuring device and horizontal and vertical magnification factors are read from both sides. The smaller of these two values is selected and entered into the magnification system of the copy machine. Whilst this apparatus assists in the determination of the magnification factor required, it does not provide a ready visual indication of the area that will be reproduced in the copying. Consequently it is difficult to visualise the appearance in the copying and in particular the position of the image on the sheet. This can only be achieved by a visualisation and estimation of the required size, subsequent determination of the two magnification factors and a selection of the smaller one for use in producing a copy.

The present invention seeks to provide a scaling template for use in copying an image which will overcome these difficulties, or at least provide a useful alternative.

### DISCLOSURE OF THE INVENTION

Accordingly, in one aspect the present invention provides an enlarging template for use in copying an image, said template comprising a sheet of material; a series of individually identifiable regions marked on said sheet, each region having a shape and area related by a scaling factor to an output sheet size of a copying machine, the scaling factor respectively corresponding to each region being indicated on said sheet, whereby the scaling factor to perform an enlarging copying operation on the copying machine in respect of an original image can be determined by positioning the original image on or under the template and determining the region on the template into which the original image fits in a desired manner.

In another aspect, the present invention provides a reducing template for use in copying an image, said template comprising a sheet of material; a series of individually identifiable regions marked on said sheet, each region having a shape and area related by a scaling factor to an imaging area of a copying machine, the scaling factor for each region being indicated on said sheet, whereby the scaling factor to perform a selected copying operation on the copying machine in respect of an original image can be determined by determining the region on the template corresponding to a desired image size.

Preferably, the sheet of material is substantially transparent or at least translucent so that for an enlarging template the area occupied by an image can be determined when the template is placed over the image. In the case of a transparent or translucent reducing template the area to be occupied by a reduced image can be determined by placing the template over the area in which the image will appear, or representative of the area in which the image will appear.

In a preferred form of the invention the location of each region on the template is related to the imaging area of the copying machine. In the case of an enlarging template the position of each region corresponds to the position in which the image to be enlarged by the associated scaling factor should be positioned within the imaging region of the copying machine. In the case of a reducing template the location of each region indicates the position on the imaging region of the copying machine in which the reduced image corresponding to the selected scaling factor will be printed.

Preferably the overall size of the template corresponds to the size of the imaging area of the copying machine which in turn preferably corresponds to a standard paper size.

The templates are preferably rectangular and the regions are defined by two intersecting edges of the template and two intersecting lines marked on the template, each of the lines being parallel to one of the intersecting edges.

Preferably the regions form a series of overlapping or nested rectangles. In the preferred form of the invention, graduations are provided between adjacent regions to allow for interpolation of the scaling factor.

It will be apparent that the templates of the present invention thus provide a ready visual indication of the area to be copied when a scaling factor corresponding to that area is selected on a copying machine. This enables the user to readily determine the most appropriate scaling factor by placing the image on or under the template. In particular appropriate border areas can easily be allowed and the image can be readily positioned by reference to the boundaries of the regions marked on the template. It will also be apparent that the template can be produced in sizes and scalings appropriate to the imaging regions of selected copying machines. The most common of these is the A4 size although the template can be easily made for use with copiers using A3, A5 or any other size or format of output sheet. Whilst it is preferred that the dimensions of the template corresponds to the size of the paper being used in the copying process it will be apparent that this is not essential and the size of the paper can be simply marked on the template if desired. The translucent templates can be provided in any suitable colour and with any degree of transparency required for particular applications.

Embodiments of the invention will now be described, by way of example only with reference to the accompanying drawings.

### BRIEF DESCRIPTION OF THE DRAWINGS

FIG. 1 is a schematic drawing of a template for enlarging in accordance with an embodiment of this invention; and

FIG. 2 is a schematic drawing of a scaling template for reducing in accordance with an embodiment of this invention.

FIG. 3 is a schematic plan view of part of a copying machine.

### DESCRIPTION OF BEST MODE FOR CARRYING OUT THE INVENTION

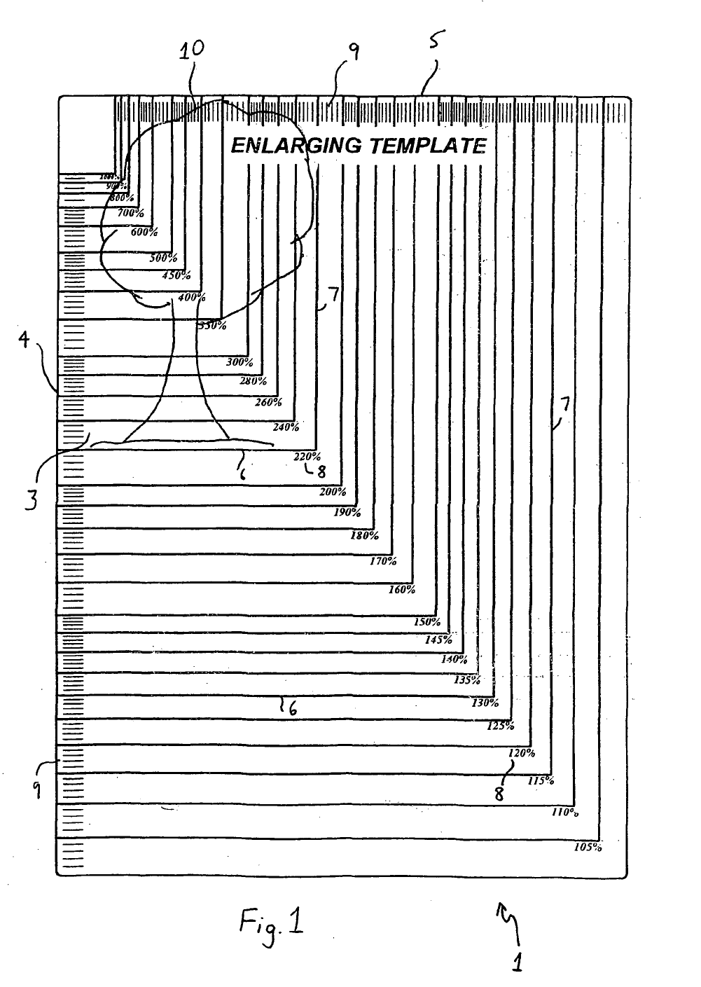

Referring to FIGS. 1, 2 and 3 the templates 1 are usually rectangular in shape and correspond to the size of paper and hence the size of one of the imaging areas of a copying machine 20. In the present example the templates are reduced images of an A4 sized template. The templates are made from a tough resilient polypropylene sheet. The sheets are translucent and preferably coloured for aesthetic purposes. In some cases the colour may be selected to improve the contrast with images of certain colours.

Referring to FIG. 1 the enlarging template 1 has a series of individually identified rectangular regions 3 defined by two intersecting edges 4, 5 of the sheet and two intersecting lines 6, 7. Each of the regions is identified with a corresponding scaling factor 8 shown here as being from 1000% to 105%. The indicia and lines are marked on the material of the template 1 using any suitable printing embossing or other marking process. Graduations 9 are provided along edged 4, 5 to provide for interpolation between the scaling factors of adjacent rectangles 3. In this regard it will be apparent that the outer most rectangle defined by the edges of the template corresponds to a scaling factor of 100%.

It will be apparent that each of the regions 3 marked on the template 1 correspond to the respective area printed on an A4 output sheet by the copying machine if the scaling factor corresponding to that region is available and selected on the machine.

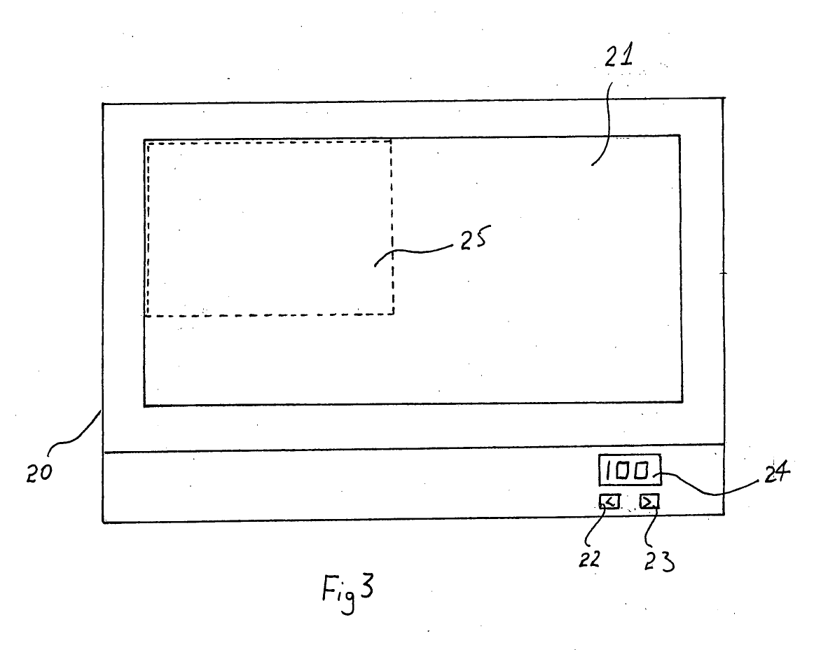

FIG. 3 schematically shows the upper part of a typical photocopying machine 20. The machine 20 includes a glass platen 21 and zoom controls 22, 22 of conventional type. The scaling factor or “zoom” selected is displayed on digital display 24. The imaging area of the machine for A4 paper is shown in dotted outline at 25. Other standard features of a copying machine have been omitted.

In use the template is used by positioning the image 10 to be enlarged and copied completely within the usually smallest rectangle that fully frames the image 10, in this case the 220% rectangle. If it is desired to have a border then this can be provided by appropriate positioning of the image 10 within a slightly larger rectangle. The amount of the border will, of course, be enlarged by the same amount as the image. Once the correct rectangle 3 is selected, the scaling factor, in this case 220%, corresponding to that rectangle 3 is selected on the copying machine 20.

The original image 10 is then placed on the window or platen 21 of the copy machine 20 in the same relative position as the image 10 was positioned in relation to the template 1. In the case of a translucent or transparent template the template can be used to improve the accuracy of positioning of the image 10 on the copying machine. In many cases it is necessary to allow for the margins on the copying machine. That is, the area of the platen 21 which is not part of the imaging area 25 of the copying machine. This is often available from the copying machine specifications or can be determined by a test copy.

Once the image 10 is positioned in this manner and the appropriate scaling factor is selected, the copying machine should print the image in the desired size (220% enlargement) on the selected paper, in this case A4. Where the desired image size falls between rectangles 3 the graduations 9 allow the user to interpolate.

If the scaling factor available on a copying machine is insufficient then the largest copy possible is made and the template is used again to determine the next scaling factor required to achieve the final enlargement to the required size.

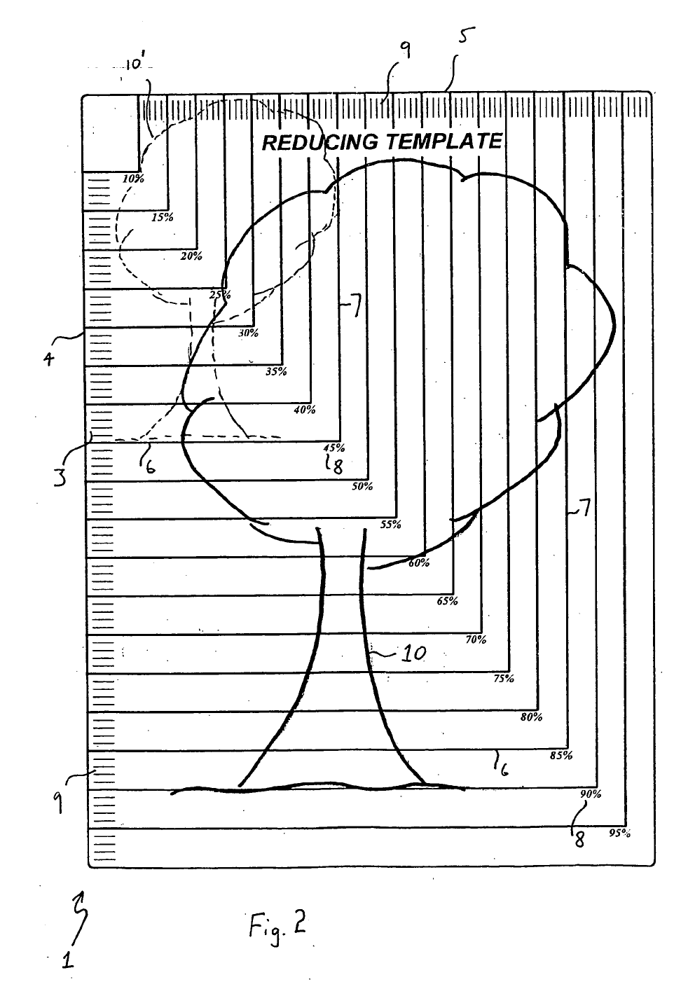

FIG. 2 shows a reducing template which is generally similar in appearance to the enlarging template 1 shown in FIG. 1. Corresponding numerals have been used for corresponding features. In the reducing template a series of individually identified rectangular regions 3 are formed by intersecting edges 4, 5 of the template 1 and two intersecting lines 6, 7 marked on the template. A scaling factor 8 corresponding to each rectangle is marked on the template 1. The scaling factors 8 on the reducing template shown vary from 10% to 95%. As with the enlarging template the lines can be formed using any suitable process. Graduations 9 are provided between the rectangles 3 to provide for interpolation between adjacent rectangles 3.

In use the reducing template 1 is used in a somewhat similar manner to the enlarging template 1. The size of the reducing template corresponds to the imaging area of the copying machine which in turn corresponds to the selected output sheet size (A4). The rectangle 3 corresponding to the desired size of the reduced copy (image 10 shown dotted) is selected in this case 45%. The scaling factor required to achieve this reduction is that corresponding to the selected rectangle. It will be apparent that the template can be used to evaluate the available area by being placed over a region in which it is desired that the image fits.

The original A4 sized sheet carrying the image 10 is placed within the imaging area 25 on platen 21 of the copying machine 20 in the usual manner. As with the enlarging template, allowance must be made for the margins of the individual copying machine. It will be appreciated that the position of image 10 within the borders of the imaging area of the copying machine (which corresponds to the borders of the reducing template 1) corresponds to where the image 10′ will appear in the 45% rectangle 3.

Using the scaling factor indicated by the corresponding rectangle the image of desired size can be printed. Where the desired image size falls between marked regions 3 the graduations allow for interpolation between the rectangles to estimate the required scaling factor. In this regard it will be apparent that the outer most rectangle defined by the edges of the template corresponds to a scaling factor of 100%.

It will be apparent that the invention facilitates the accurate determination of the required scaling factor for enlargement or reduction of images on copying machines such as photocopiers and scanners. The need for trial and error and the corresponding wastage of materials is thus avoided.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgement or any form of suggestion that that prior art forms part of the common general knowledge in Australia.

The foregoing describes only some embodiments of the invention and modifications can be made without departing from the scope of the invention.

1. An enlarging template for use in copying an image, said template comprising a sheet of material; a series of individually identifiable regions marked on said sheet, each region having a shape and area related by a scaling factor to an output sheet size of a copying machine, the scaling factor respectively corresponding to each region being indicated on said sheet, whereby the scaling factor to perform an enlarging copying operation on the copying machine in respect of an original image can be determined by positioning the original image on or under the template and determining the region on the template into which the original image fits in a desired manner.

2. An enlarging template as claimed in claim 1 wherein said material is translucent so that the area occupied by an image can be determined when the template is placed over the image.

3. An enlarging template as claimed in claim 1 or claim 2 wherein the location of each region is related to the imaging area of the copying machine.

4. An enlarging template as claimed in claim 3 wherein the position of each region corresponds to the position in which the image to be enlarged by the associated scaling factor should be positioned within the imaging region of the copying machine.

5. An enlarging template as claimed in claim 1 where the dimensions of the template correspond to the size of an imaging region of the copying machine and an output sheet size.

6. An enlarging template as claimed in claim 5 wherein said output sheet is a standard sheet size.

7. An enlarging template as claimed in claim 1 where the template is rectangular and the regions are defined by two intersecting edges of the template and two intersecting lines marked on the template each of the lines being parallel to one of the intersecting edges.

8. An enlarging template as claimed in claim 7 wherein the regions form a series of overlapping rectangles.

9. An enlarging template as claimed in claim 8 wherein graduations are provided between adjacent rectangles to provide for interpolation of the scaling factor.

10. A reducing template for use in copying an image, said template comprising a sheet of material; a series of individually identifiable regions marked on said sheet, each region having a shape and area related by a scaling factor to an imaging area of a copying machine, the scaling factor for each region being indicated on said sheet, whereby the scaling factor to perform a selected copying operation on the copying machine in respect of an original image can be determined by determining the region on the template corresponding to a desired image size.

11. A reducing template as claimed in claim 10 wherein said material is translucent so that the area to be occupied by a reduced image can be determined when the template is placed over an area in which the image will appear.

12. A reducing template as claimed in claim 1 wherein the location of each region is related to the imaging area of the copying machine.

13. A reducing template as claimed in claim 12 wherein the position of each region corresponds to the position in which the image to be reduced by the associated scaling factor will be positioned within the region corresponding to the selected scaling factor.

14. A reducing template as claimed in claim 1 where the dimensions of the template correspond to the size of an imaging region of the copying machine and an output sheet size.

15. A reducing template as claimed in claim 14 wherein the output sheet is a standard sheet size.

16. A reducing template as claimed in claim 1 where the template is rectangular and the regions are defined by two intersecting edges of the template and two intersecting lines marked on the template each of the lines being parallel to one of the intersecting edges.

17. A reducing template as claimed in claim 16 wherein the regions form a series of overlapping rectangles.

18. A reducing template as claimed in claim 17 wherein graduations are provided between adjacent rectangles to provide for interpolation of the scaling factor.
